(19) United States
(12) Patent Application Publication
(10) Pub. No.: US 2006/0031599 A1
(43) Pub. Date: Feb. 9, 2006

(54) Shared led control within a storage enclosure via modulation of a single led control signal

(75) Inventors: Matthew D. Bomhoff, Tucson, AZ (US); Brian J. Cagno, Tucson, AZ (US); Gregg S. Lucas, Tucson, AZ (US); Kenny N. Qiu, Tucson, AZ (US)

Correspondence Address: SCULLY, SCOTT, MURPHY, & PRESSER, 400 GARDEN CITY PL, GARDEN CITY, NY, 11530, US

(73) Assignee: International Business Machines Corporation, Armonk, NY (US)

(21) Appl. No.: 10/914,709

(22) Filed: Aug. 9, 2004

(51) Int. Cl. G06F 13/10

(52) U.S. Cl. 710/15

(57) ABSTRACT

An indicator light, such as an LED, for a computer disk drive module is controlled via an external controller. The disk drive module monitors a disk drive and determines a desired state of the LED, such as on, off or flashing, to indicate a status of the disk drive. The disk drive module provides a modulated signal carrying data that identifies the desired state on a path coupled to the indicator light and a terminal that is accessed by the external controller. The controller implements an algorithm for driving the indicator light, where the algorithm receives, as a first input, the desired state determined from the demodulated signal and, as a second input, information obtained from monitoring the disk drive module. The controller itself may obtain this information or receive it from a higher-level system controller.

### BACKGROUND OF THE INVENTION

1. Field of the Invention

The invention relates generally to the field of computer systems and, more specifically, to a technique for driving an indicator light for a disk drive module.

2. Description of the Related Art

Computer disk drives commonly use indicator lights such as light-emitting diodes (LEDs) to indicate a status of the drive. Information regarding a status of the disk can be conveyed by turning the light on or off in a steady or flashing manner. For example, the light may be off when the drive is unpowered or being powered up, and therefore unavailable for use. The light may be on steady when the drive has powered up with no errors and is ready for use. The light may flash in various on-off sequences to indicate that the disk is in use writing or reading data, that there has been a power loss or other fault condition, or other status information regarding the drive.

Disk drives used for some storage servers and other computer devices may not have built-in indicator lights. Instead, one or more indicator lights may be provided on the second level packaging. For example, the indicator light may be located on the backplane of the disk drive enclosure. In a Fibre Channel storage enclosure, for instance, lightpipes can be run from the backplane to the front of the disk drives, such as the front of each hard disk drive bezel, via the disk drive module carrier to allow the operator to easily view the indicator lights. However, this approach is problematic as technology migrates toward small form factor (SFF) disk drives, such as 2.5-inch disk drives, from the current 3.5-inch drives. In this case, there is insufficient space for a lightpipe from each disk drive module carrier to be implemented since multiple hard disk drives are packaged within a carrier or substructure. Maintaining the indicator lights on the backplane is impractical since the operator cannot easily view them.

### BRIEF SUMMARY OF THE INVENTION

The present invention provides apparatuses for addressing the above and other issues by providing a mechanism to share control of an indicator light over a single signal path.

In one aspect of the invention, a disk drive and controller assembly includes a disk drive module including a disk drive, a circuit for monitoring the disk drive, and a conductive path extending from the circuit to an indicator light and to a terminal that is accessible external to the disk drive module. The circuit provides, via the conductive path, and responsive to the monitoring, a modulated signal identifying a desired state of the indicator light. A controller, external to the disk drive module, is provided for receiving the modulated signal from the disk drive module via the terminal, demodulating the modulated signal to determine the desired state, and implementing an algorithm for driving the indicator light. The algorithm receives, as a first input, the desired state determined from the demodulated signal and, as a second input, information obtained from monitoring the disk drive module.

In a further aspect of the invention, a disk drive module includes a disk drive, a circuit for monitoring the disk drive, and a conductive path extending from the circuit to an indicator light and to a terminal that is accessible external to the disk drive module. The circuit provides, via the conductive path, a modulated signal identifying a desired state of the indicator light responsive to the monitoring. The modulated signal is provided with a pulse width time that is sufficiently small so that the indicator light is not perceived by a human as being illuminated by the modulated signal, by itself.

In yet another aspect of the invention, a controller for a disk drive module includes a first circuit, external to the disk drive module, for receiving from the disk drive module, via a terminal of the disk drive module that is accessible external to the disk drive module, a modulated signal identifying a desired state of an indicator light in the disk drive module, demodulating the modulated signal to determine the desired state, and implementing an algorithm for driving the indicator light. A second circuit, which is in the disk drive module, monitors the disk drive and provides the modulated signal, via a conductive path in the disk drive module extending from the second circuit to the indicator light and to the terminal, responsive to the monitoring. The algorithm receives, as a first input, the desired state determined from the demodulated signal and, as a second input, information obtained from monitoring the disk drive module.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates an arrangement for controlling an indicator light of a disk drive module, where multiple signal lines are needed across a backplane/controller card connector; and

FIG. 2 illustrates an arrangement for controlling an indicator light of a disk drive module according to the invention, where only a single signal line is needed across a backplane/controller card connector.

### DETAILED DESCRIPTION OF THE INVENTION

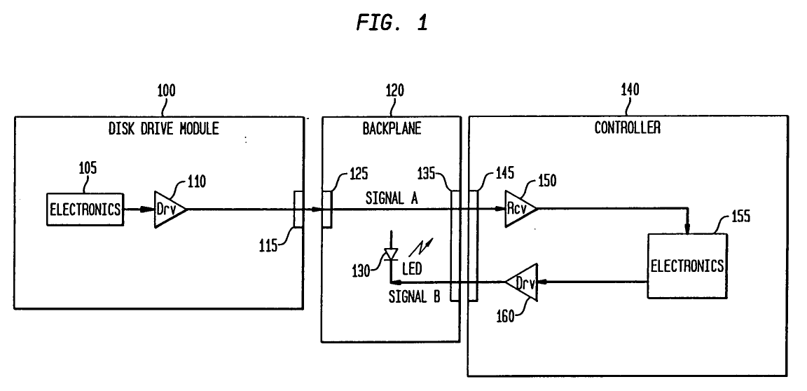

FIG. 1 illustrates an arrangement for controlling an indicator light of a disk drive module, where multiple signal lines are needed across a backplane/controller card connector. One approach to packaging indicator lights such as LEDs is to provide the disk drive module itself with the indicator lights. However, this necessitates some type of shared access to control the states of the indicator lights. FIG. 1 illustrates a disk drive module 100, backplane 120 with indicator light 130, and a controller 140. A disk drive module generally refers to a structural carrier or housing that the disk drive electronics are provided within. One or more disk drive modules are typically installed into a higher-level assembly, such as a chassis, in a computer system such as a storage server. For example, in the IBM Enterprise Storage Server (ESS), eight-packs of disk drive modules are installed together. The disk drive module is installed into a backplane of the chassis. A latch in the front of the module locks it in place. The disk drive module is a field replaceable unit that can be quickly replaced if repair or replacement is needed. Other components such as controller cards can be installed in the backplane as well.

Each indicator light can be illuminated by the disk drive module 100 generating a signal from the hard disk drive electronics 105 through its driver 110, and through its connector 115 and the mating backplane connector 125, through the backplane wiring and a further connector 135, and into the controller card 140 via its connector 145. The controller card 140 receives the signal from the disk drive module 100, and generates a subsequent signal based on the disk drive's signal as well as internal controller card logic implemented in the electronics 155. The subsequent signal is driven onto the backplane 120, via the driver 160 and connector 145, and connected to the indicator light 130 which, in turn, is appropriately activated, sending optical signals through the light pipes to the front of the disk drive module 100.

In particular, the disk drive module 100 does not directly turn the indicator light 130 on and off by generating a signal, signal A, that is wired to the backplane 120/disk drive connector 115. Instead, signal A is wired through the backplane 120 to the controller electronics 155, where the controller generates a subsequent signal, signal B, that is directly related to the disk drive's incoming signal or that is related to the controller's desired behavior of the light indicator 130. In either case, a signal is sent back to the backplane 120, where it is connected to one or more backplane LEDs 130. Lightpipes within the disk drive carrier carry the light information from the backplane LED to the front bezel of the disk drive. Note that for each LED, two signals (signal A and signal B) must cross the backplane/controller card connector 135, 145 on separate signal paths. For typical state of the art enclosures (e.g., with sixteen disk drive modules), thirty-two signal lines are required.

One option is to employ embedded LEDs within the carrier, allowing the LED signal path to be much more straightforward. However, one shortcoming of this approach is that the LED signal is kept local to the disk drive module, so there is no clear way for the external controller card 140 to affect the LED state.

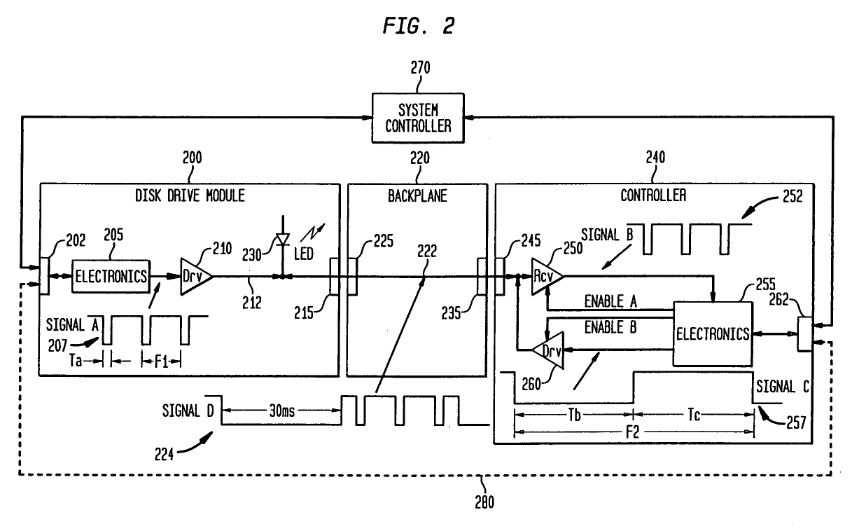

FIG. 2 illustrates an arrangement for controlling an indicator light of a disk drive module according to the invention, where only a single signal line is needed across a backplane/controller card connector. FIG. 2 illustrates a disk drive module 200 including electronics/circuitry 205, a driver 210, an indicator LED 230, and a connector or terminal 215. The indicator light 230 can be internal or external to the disk drive module 200. A backplane 220 includes connectors or terminals 225 and 235. A controller 240 includes a connector or terminal 245, a receiver (Rcv) 250, electronics/circuitry 255, and a driver (Drv) 260.

In a particular embodiment, a single LED control signal for Fibre Channel Arbitrated Loop (FC-AL) disk drives (also part of the SFF-8045 Fibre Channel specification) can be used. Custom drive firmware and/or microcode can be implemented in the disk drive electronics/circuitry 205 to modulate the LED control signal to carry information regarding a desired state of the LED. The disk drive electronics/circuitry 205 can include a microprocessor, ASIC or other control device. Three major LED states are: 1) off, 2) on solid, and 3) on blinking. Complementary enclosure electronics 255 can be implemented in the controller card 240 to sense this modulation and remodulate the control signal so as to properly manage the LED on, off and blinking states. In this case, both the disk drive module 200 and the controller 240 control the state of the LED 230.

The electronics/circuitry 205 of the disk drive module provides a signal A (207) on signal path 212 with a frequency F1 and pulse width Ta. The cathode/common wire of the LED 230 may be coupled to the signal path 212 so that a high voltage signal maintains the LED 230 in the off state, while a low voltage signal turns the LED 230 on. Other indicator lights such as incandescent lamps or other polarized light transmitters may also be used. Signal B (252) at the controller 240 is similar to signal A (207). Signal C (257) is the signal output from the electronic/circuitry 255 of the controller 240, and has a frequency F2 and pulse widths Tb and Tc as indicated. Signal D (224) on signal path 222, which is the signal that controls the LED 230, is a superposition of signal A (207) and signal C (257). A low voltage pulse duration of 30 msec. is indicated as an example.

The disk drive module 200 itself does not directly control the LED 230, but it communicates the desired LED state to the controller 240 by modulating the shared LED signal at a rate of F1. Each desired state of the indicator light is identified by a unique F1 frequency (see signal A). F1 should be sufficiently faster than F2/2 in order for the controller electronics 255 to be able to correctly decode the modulated signal B. Thus, the modulated signal should be provided at a frequency that is sufficiently faster than a frequency at which the controller 240 drives the indicator light 230 so that the modulated signal can be demodulated by the controller 240. Different blink rates can be accommodated by defining additional F1 rates. Note that the pulse width time of signal A should be sufficiently small such that the LED 230 is not perceived by a human as being illuminated by signal A (207) alone. Thus, the modulated signal should be provided with a pulse width time that is sufficiently small so that the modulated signal is not perceived as being illuminated by the modulated signal, by itself. The user can only perceive when the LED 230 responds to low frequency signals, but not a short/fast pulse.

The controller electronics 255 monitor the incoming modulated signal (signal B) only during specific time windows (Tc). To achieve this, the “enable A” signal to the receiver (Rcv) 250 controls when the electronics 255 receive an input, while the “enable B” signal controls when the driver (Drv) 260 provides an output. Once the controller 255 has decoded signal B, it transmits signal C. There may be some hysteresis built into the decoding algorithm. That is, the controller 140 may be constantly monitoring signal B. When a change is detected, the controller 140 waits a fixed amount of time for signal B to stabilize. This can also be considered debouncing the signal, in a sense.

To turn the LED off, signal C can be a static DC high level (i.e., Tb=0). To turn the LED on solid, signal C can alternate at a frequency F2 and a duty cycle of Tb/Tc so as to be visible to the human eye as a solid on indication (e.g., F2=60 Hz and Tb/Tc=50%). Similarly, to blink the LED, signal C can alternate at a frequency of F2 and a duty cycle of Tb/Tc so as to be visible to the human eye with the predescribed blink rate (e.g., F2=2 Hz and Tb/Tc=50%). Generally, both steady on and blinking are achieved by causing the Signal D to oscillate at some frequency F2. The faster rate, e.g., 60 Hz, is so fast that the eye perceives the LED as being solid on when, in fact, it is just blinking faster than the eye can perceive. When F2 is slowed down to below, e.g., 30 Hz, such as 2 Hz, the eye starts to perceive the light as pulsating or blinking. According to the invention, only a single signal (signal D) is required to be wired through the backplane. This is especially advantageous for the Fibre Channel standard, which allows only one signal path output from the disk drive module 200.

In one possible approach, a higher-level system controller 270 may communicate with the electronics/circuitry 205 of the disk drive module 200, via a connector 202, to instruct the disk drive module 200 to read or write data, for example. The system controller 270 maintains its own status information regarding the disk drive module 200, e.g., to determine when there is a fault at the disk drive module 200. For instance, the system controller 270 may learn that there is a fault at the disk drive module 200 when it instructs it to store data, but does not receive a confirmation signal back from the disk drive module 200 within a set amount of time. The system controller 270 can also communicate with the controller 240 of the disk drive module 200, specifically with the electronics/circuitry 255, via a connector 262, to inform it of the fault or other status information regarding the disk drive module 200.

In another possible approach, the controller 240 itself performs the functions of the higher-level system controller 270 discussed above, e.g., in obtaining system level information about the disk drive condition. Specifically, the controller 240 may communicate with the electronics/circuitry 205 of the disk drive module 200, via the connector 202 and communication path 280, to instruct the disk drive module 200 to read or write data, for example. The controller 240 maintains its own status information regarding the disk drive module 200, e.g., to determine when there is a fault at the disk drive module 200.

The electronics/circuitry 255 can implement an algorithm, e.g., by executing custom firmware and/or microcode, to determine how to drive the LED 230. The electronics/circuitry 255 can include a microprocessor, ASIC or other control device. This algorithm can receive the desired indicator light state information from the disk drive module 200 as one input, and the status information obtained from monitoring the disk drive module, e.g., from the controller 240 itself or from the system controller 270, as another input. The electronics/circuitry 255 can essentially override the desired state in driving the indicator light 230 when the algorithm determines that the desired state conflicts with the information obtained from monitoring the disk drive module 200. For example, the disk drive module 200 may set the desired state to steady on, indicating no faults are present. If the information obtained from monitoring the disk drive module 200 indicates that there is a fault present, the electronics/circuitry 255 can set the LED 230 to an appropriate blinking state that identifies the fault. The controller 240 can also drive the indicator light consistent with the desired state when the algorithm determines that the desired state does not conflict with the information obtained from monitoring the disk drive module 200. For example, the disk drive module 200 may again set the desired state to steady on, indicating no faults are present. If the information obtained from monitoring the disk drive module 200 also indicates that there are no faults present, the electronics/circuitry 255 can set the LED 230 to the desired steady on state. The invention thus allows the controller 240 to implement additional intelligence and decision-making criteria beyond that provided by the disk drive module 200 in determining how to drive the indicator light 230.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A disk drive and controller assembly, comprising:
a disk drive module including a disk drive, a circuit for monitoring the disk drive, and a conductive path extending from the circuit to an indicator light and to a terminal that is accessible external to the disk drive module;
wherein the circuit provides, via the conductive path, and responsive to the monitoring, a modulated signal identifying a desired state of the indicator light; and
a controller, external to the disk drive module, for receiving the modulated signal from the disk drive module via the terminal, demodulating the modulated signal to determine the desired state, and implementing an algorithm for driving the indicator light;
wherein the algorithm receives, as a first input, the desired state determined from the demodulated signal and, as a second input, information obtained from monitoring the disk drive module.

2. The disk drive and controller assembly of claim 1, wherein:
the modulated signal is provided at respective different frequencies to identify respective different desired states of the indicator light.

3. The disk drive and controller assembly of claim 1, wherein:
the controller overrides the desired state in driving the indicator light when the algorithm determines that the desired state conflicts with the information obtained from monitoring the disk drive module; and
the controller drives the indicator light consistent with the desired state when the algorithm determines that the desired state does not conflict with the information obtained from monitoring the disk drive module.

4. The disk drive and controller assembly of claim 1, wherein:
the modulated signal is provided with a pulse width time that is sufficiently small so that the indicator light is not perceived as being illuminated by the modulated signal, by itself.

5. The disk drive and controller assembly of claim 1, wherein:
the modulated signal is provided at a frequency that is sufficient faster than a frequency at which the controller drives the indicator light so that the modulated signal can be demodulated by the controller.

6. The disk drive and controller assembly of claim 1, wherein:
the indicator light comprises a light-emitting diode (LED).

7. The disk drive and controller assembly of claim 1, wherein:
the indicator light is internal to the disk drive module.

8. The disk drive and controller assembly of claim 1, wherein:
the indicator light is external to the disk drive module.

9. The disk drive and controller assembly of claim 1, wherein:
the controller monitors the disk drive module to obtain the information.

10. The disk drive and controller assembly of claim 1, wherein:
a higher-level system controller monitors the disk drive module to obtain the information and provide the information to the controller.

11. A disk drive module, comprising:
a disk drive, a circuit for monitoring the disk drive, and a conductive path extending from the circuit to an indicator light and to a terminal that is accessible external to the disk drive module; wherein:
the circuit provides, via the conductive path, a modulated signal identifying a desired state of the indicator light responsive to the monitoring; and
the modulated signal is provided with a pulse width time that is sufficiently small so that the indicator light is not perceived as being illuminated by the modulated signal, by itself.

12. The disk drive module of claim 11, wherein:
a controller, external to the disk drive module, is provided for receiving the modulated signal from the disk drive module via the terminal, demodulating the modulated signal to determine the desired state, and implementing an algorithm for driving the indicator light; and
the algorithm receives, as a first input, the desired state determined from the demodulated signal and, as a second input, information obtained from monitoring the disk drive module.

13. The disk drive module of claim 11, wherein:
the controller overrides the desired state in driving the indicator light when the algorithm determines that the desired state conflicts with the information obtained from monitoring the disk drive module; and
the controller drives the indicator light consistent with the desired state when the algorithm determines that the desired state does not conflict with the information obtained from monitoring the disk drive module.

14. The disk drive module of claim 11, wherein:
the modulated signal is provided at a frequency that is sufficiently faster than a frequency at which the controller drives the indicator light so that the modulated signal can be demodulated by the controller.

15. The disk drive module of claim 11, wherein:
the indicator light is internal to the disk drive module.

16. The disk drive module of claim 11, wherein:
the indicator light is external to the disk drive module.

17. A controller for a disk drive module, comprising:
a first circuit, external to the disk drive module, for receiving from the disk drive module, via a terminal of the disk drive module that is accessible external to the disk drive module, a modulated signal identifying a desired state of an indicator light in the disk drive module, demodulating the modulated signal to determine the desired state, and implementing an algorithm for driving the indicator light; wherein:
a second circuit, which is in the disk drive module, monitors the disk drive and provides the modulated signal, via a conductive path in the disk drive module extending from the second circuit to the indicator light and to the terminal, responsive to the monitoring; and
the algorithm receives, as a first input, the desired state determined from the demodulated signal and, as a second input, information obtained from monitoring the disk drive module.

18. The controller of claim 17, wherein:
the modulated signal is provided at a frequency that is sufficiently faster than a frequency at which the controller drives the indicator light so that the modulated signal can be demodulated by the controller.

19. The controller of claim 17, wherein:
the modulated signal is provided with a pulse width time that is sufficiently small so that the indicator light is not perceived as being illuminated by the modulated signal, by itself.

20. The controller of claim 17, wherein:
the first circuit overrides the desired state in driving the indicator light when the algorithm determines that the desired state conflicts with the information obtained from monitoring the disk drive module; and
the first circuit drives the indicator light consistent with the desired state when the algorithm determines that the desired state does not conflict with the information obtained from monitoring the disk drive module.
